(19) United States
(12) Patent Application Publication
(10) Pub. No.: US 2011/0285308 A1
(43) Pub. Date: Nov. 24, 2011

(54) Dimmable thermally controlled safety light emitting diode illumination device

(76) Inventors: Bonnie A. Crystal, San Mateo, CA (US); Sik Hing Yuen, Foster City, CA (US); Pui Hang Yuen, Fotan (HK)

(21) Appl. No.: 12/800,740

(22) Filed: May 20, 2010

(51) Int. Cl. H05B 41/24

(52) U.S. Cl. 315/287

(57) ABSTRACT

A Light Emitting Diode safety illumination device with thermal control and dimming compatibility for use with incandescent light dimmers and light fixtures. Circuit method and structure combine to provide thermal curve management of temperature control parameters overriding and taking priority over power and dimming of the intensity of illumination.

A novel device is described herein specified with descriptive drawings, of the new invention of a Light Emitting Diode safety illumination device having qualities of thermal control, ability to be compatible and interoperable with existing prior art light dimmers, and with existing prior art light fixtures.

Prior art Light Emitting Diode illumination devices are generally incompatible with incandescent style pulse width modulated light dimmers. This incompatibility is mainly due to deficiencies in the design of the circuitry and thermal management of the prior art LED devices which fail to provide conversion of the impulses typically outputted by the dimmer. The failure usually results in thermal problems, safety problems, or lack of variability in the luminance of the prior art devices.

An object of this invention is a safe and thermally compatible illumination device utilizing light emitting diodes, with a structure enabling the retrofit of the device into lighting fixtures which were originally intended for incandescent light bulbs or compact fluorescent lighting devices.

The circuitry of the invention provides interface with AC mains source power which has been pulse modulated via dimming adjustments external to the device. This invention circuitry utilizes reference voltage stabilized control with overriding optoisolator thermal circuitry to enable the invention illumination device to remain at a safe temperature.

Safe temperature is needed to prevent fires and to prevent harm to humans. The invention structure contains a control circuit and light emitting diodes with a heat sink and control circuit shielded cavity with a mounting method as shown in the drawings.

Protective membranes provide safe insulation for differentials in heat to prevent burns and voltage to prevent human electrical shock.

A differential control circuit provides priority of heat control over-riding dimming control, to enable the safe control of heat under all conditions of variable AC line voltage and dim or bright settings of external dimming apparatus.

### DRAWING FIGURES

FIG. 1 is an exterior view of a preferred embodiment of the invention showing features and placement of structural, optical, mechanical, and safety membranes of the illumination device.

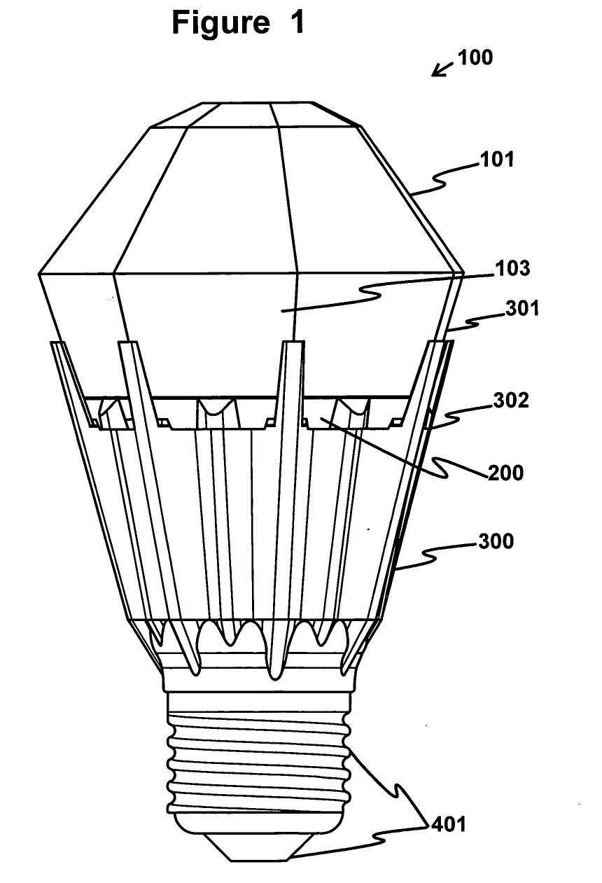

FIG. 2 is a cross-section view of an embodiment of the invention showing placement of structural, optical, thermal, illumination, safety components, and electronic circuitry of the illumination device.

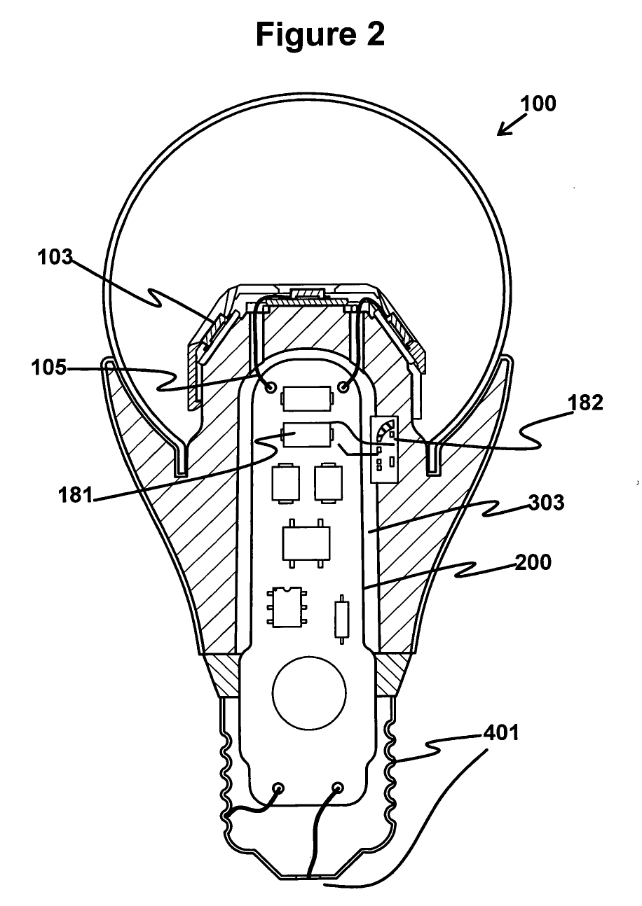

FIG. 3 is a circuitry schematic representation of a preferred embodiment of the electrical parts of the invention showing thermal control and thermal overriding dimmable and opto-isolation components.

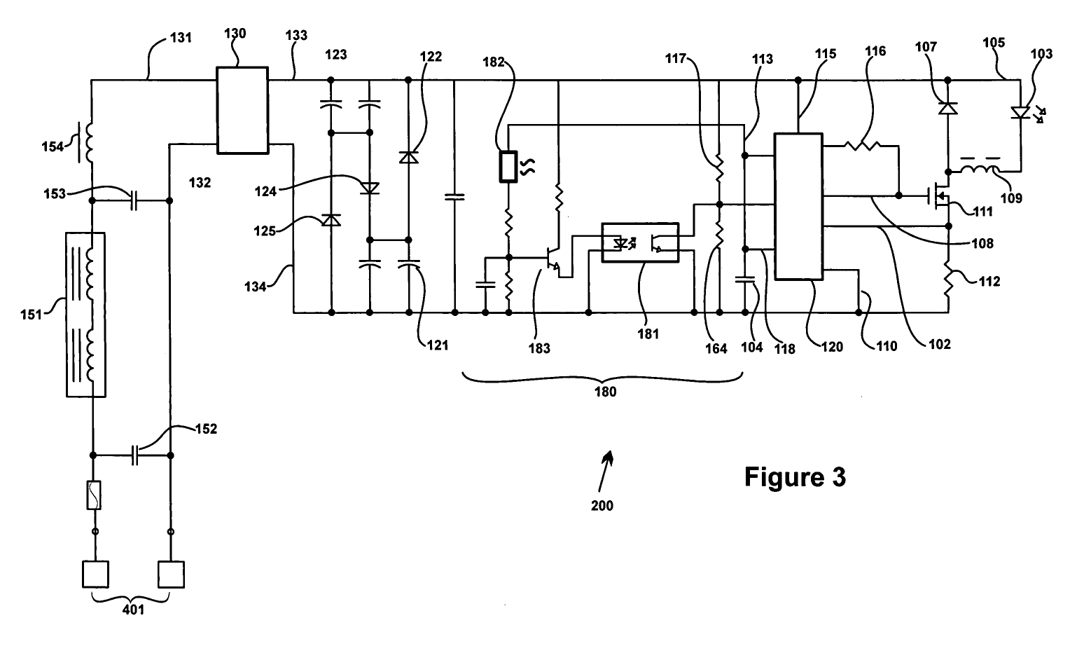

FIG. 4 is a circuitry schematic representation of a preferred embodiment of the electrical parts of the invention showing dimming compatibility control components.

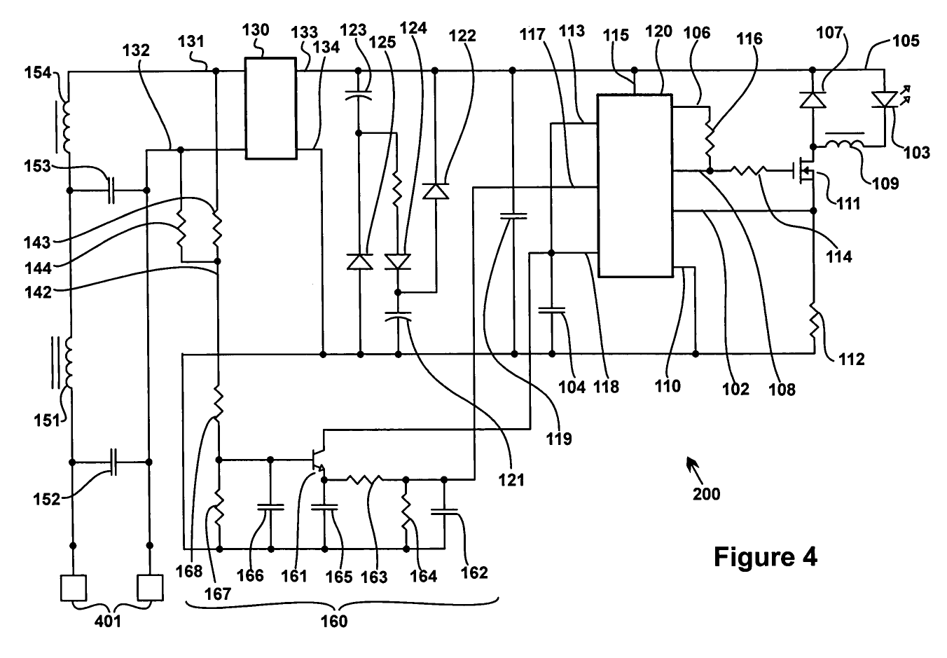

FIG. 5 is a circuitry schematic representation of an embodiment of the electrical parts of the invention showing dimming compatibility control components with pulse dimming sensing and rectification components.

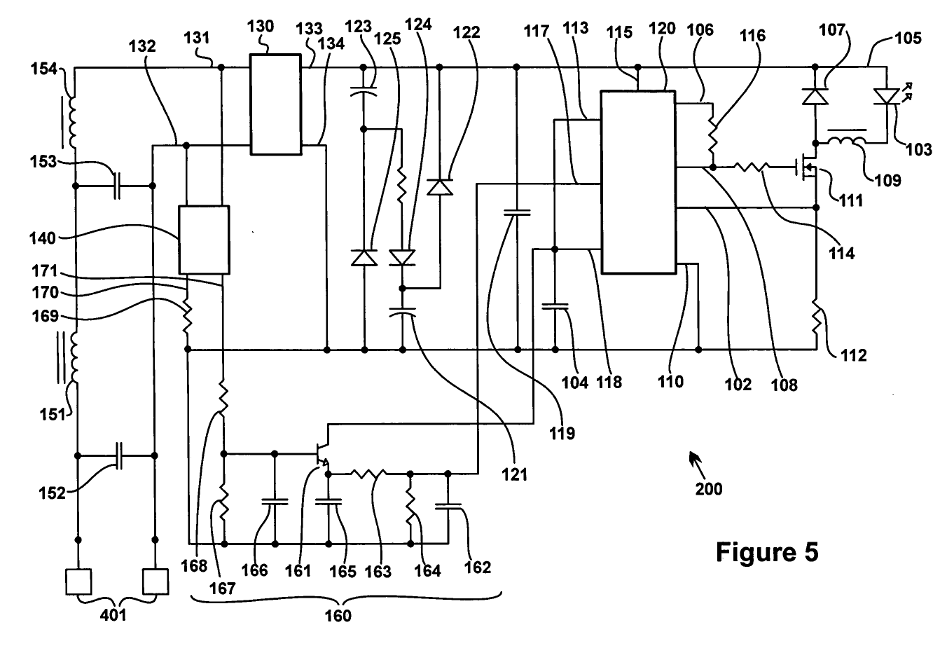

FIG. 6 is a detailed circuitry schematic representation of an embodiment of the electrical parts of the invention showing pulse modulation control for integration of the dimming, thermal management, and current limiting.

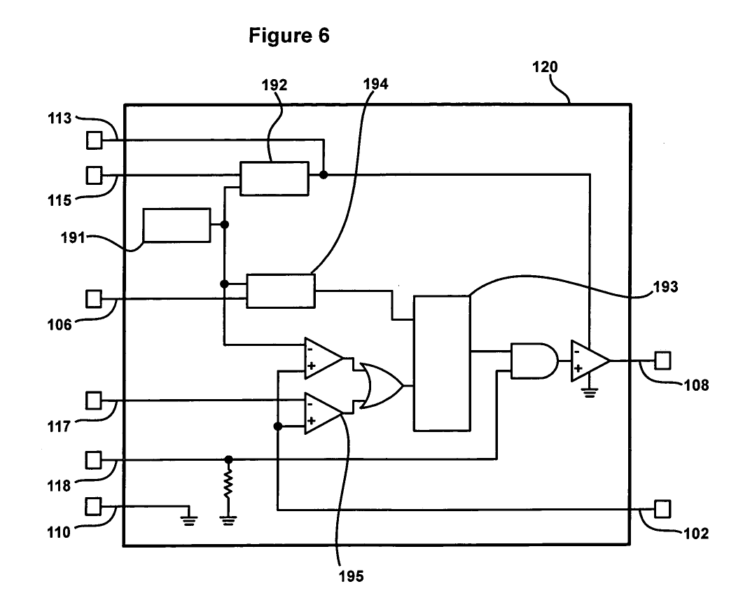

### DETAILED DESCRIPTION SPECIFYING PARTS OF THE INVENTION

The following list presents a detailed description of various parts of the preferred embodiments shown and numbered in the drawing figures of the invention and how these parts are operatively connected and function to provide the objectives of the invention:
100 Dimmable Thermally Controlled Light Emitting Diode Illumination Device
102 Current sensing connection senses the voltage corresponding to the current in the transistor circuit driving the LED illumination devices
103 Shows a schematic symbol representing a single Light Emitting Diode or a plurality of Light Emitting Diode illumination components emitting photonic light in series or in parallel which are contained within the invention structure and emanate light toward the useful illumination areas surrounding the invention
104 Capacitor providing low pass shunt filtering and integration of the voltage at 118 control connection
105 Connection between control circuitry and illumination Light Emitting Diodes
106 Oscillator resistor connection to the oscillator
107 Diode with polarity reversed from the direction of flow to provide direction of current flow and charging or discharging of the inductor 109
108 Pulse Width Modulated connection provides the variable pulse modulated drive signal used to drive the gate or base of drive transistor or other driver which then controls pulses of power for the LED illumination diodes
109 Inductor providing series inductance for powering the Light Emitting Diodes 103 through the transition of cyclic modulated pulse of voltage
111. Transistor providing current power drive switching to the Light Emitting Diodes 103 through the inductor 109 with impulses and current limiting integration averaging
112 Current sensing resistor which develops voltage corresponding to the instantaneous current drive to the
113 Positive voltage power supply connection from the stabilized voltage regulator providing power to operate the circuitry
114 Resistor connecting with the transistor 111 gate and the pulse modulated output of the circuit 120 providing current limiting and integration
115 Capacitor proving shunt filtering of pulse width modulation control reference connection 118 of the circuit 120
117 Control Connection for the Pulse Width Modulation Differential Amplifier
118 Pulse Width Modulation Control Connection turns on the PWM output to output 108
119 Capacitor providing filtering of voltage to reduce high frequency ripple in the power supply rail
120 Detailed circuit block providing driver control and pulse width modulated integrated current limiting control function for combination of dimming linearization translating the curve of integrated pulse width modulated input from the AC line to the pulse width modulated drive for the illuminating Light Emitting Diode components 103 yielding a dimmed light output that corresponds to the AC line dimmer selected adjustment of brightness while providing thermal safety protection
121 Capacitor providing boost of voltage to incoming supply pulse modulated impulses and filtering of voltage
122 Diode rectifier component providing pumping boost of voltage to capacitors
123 Capacitor providing boost of voltage to incoming supply pulse modulated impulses and filtering of voltage
124 Diode rectifier component providing pumping boost of voltage to capacitors
125 Diode rectifier component providing pumping boost of voltage to capacitors
130 Bridge rectifier components providing rectification of incoming pulse modulated alternating current
131 Connection between one side of the line of the incoming filtered AC voltage and the bridge rectifier
132 Connection between one side of the line the incoming filtered AC voltage and the bridge rectifier
133 Connection of the output of the bridge rectifier proving positive voltage impulses to power the circuitry and the illumination diodes
140 Bridge rectifier connected to the filtered AC line for sensing pulse width modulated dimming from the external dimmer adjustment
142 Connection of the sensed resistively-summed output of the filtered AC line for sensing pulse width modulated dimming from the external dimmer adjustment
143 Resistor connection for sensing the 131 connection of filtered AC line pulse modulation for sensing pulse width modulated dimming from the external dimmer adjustment
144 Resistor connection for sensing the 132 connection of filtered AC line pulse modulation for sensing pulse width modulated dimming from the external dimmer adjustment
151 Inductor providing series low pass filtering of alternating frequency transients for electromagnetic compatibility
152 Capacitor providing shunt low pass filtering of alternating frequency transients for electromagnetic compatibility
153 Capacitor providing shunt low pass filtering of alternating frequency and integration for pulses
154 Inductor providing series low pass filtering of alternating frequency and integration for pulses
160 Circuit providing dimming conversion which converts the pulse width modulated voltage from the external light dimmer on the AC line over to the control voltage corresponding to the current drive to the LED providing integrated luminance output with a similar curve of adjustment as an incandescent light bulb would be controlled by the same or similar dimmer
161 Transistor part of the dimming conversion sensing circuit
162 Capacitor low pass shunt integrator for dimming conversion sensing control and providing integration of the voltage curve response
163 Resistor series low pass integrator feeding the 162 capacitor
164 Resistor shunt impedance for the dimming conversion control circuit for bias level setting of sensor control
165 Capacitor low pass shunt integrator for dimming conversion sensing control and providing integration of the voltage curve response
166 Capacitor low pass shunt integrator for sensor dimming conversion control and providing integration of the voltage curve response
167 Resistor shunt impedance part of the voltage divider for the dimming conversion control circuit
168 Resistor series impedance part of the voltage divider for the dimming conversion control circuit connection to the filtered AC line
169 Resistor for isolation and connection to the common reference connection of the circuitry for the dimming conversion control circuit connection to the filtered AC line
170 Negative output of bridge rectifier 140 for sensing pulse width modulated dimming from the external dimmer adjustment
171 Positive output of bridge rectifier 140 for sensing pulse width modulated dimming from the external dimmer adjustment
180 Optoisolated circuitry for thermal management and limiting providing dimming override of current driving the Light Emitting Diodes
181 Optoisolator for safety isolation and pulse integration providing control of thermal override and programming of the limiting of the integrated current provided to the 103 Light Emitting Diodes
182 Thermal sensor operatively connected with the heat sink and other parts of the invention to provide temperature measurement for safety thermal override control
183 Circuit for temperature measurement and thermal sensing control
191 Voltage Reference Device provides a stable DC reference voltage to the Voltage Regulator 192 and the Oscillator 194
192 Power supply voltage regulator provides a regulated positive supply voltage for the circuit from the unregulated voltage supplied at the voltage input
193 Pulse width modulation control circuit produces a modulating signal of a set amplitude and varying duty cycle to control the brightness of LED illuminating devices
194 Pulse width modulation oscillator controls the frequency of the modulating signal of the pulse width modulation control circuit 193
195 Differential amplifiers controlling the output of the pulse width modulation circuit
200 Control circuitry of the invention
300 Heat sink shielded enclosure
301 Safety membrane
302 Safety coatings of the heat sink and enclosure
303 Shielded cavity for 120 control circuit and 182 thermal sensor
401 Alternating Current AC mains connection

The circuit 200 controls the luminance output of the light emitting diodes. When an external incandescent type lighting dimmer applies pulse width modulated voltage AC input power supply to the input 401 of the invention, this voltage is filtered by the circuitry composed of parts 152, 151, 153, and 154.

The pulse width modulated AC input power supply from the light dimmer is adjusted by a user with the intention of controlling the luminance of light for illumination of an area of use. The external dimmer control provides variable pulse width or frequency which is normally averaged in an incandescent bulb to yield a smooth transition of variable brightness.

When the invention illumination device circuit 200 receives the pulses of voltage from the external dimmer, it integrates the variable intended pulse amplitude frequency and width into a converted variable current to the light emitting diodes 103.

In a preferred embodiment of the device, a combination of dimming circuit 160 is operatively connected and combined with thermal sensing circuit 180 in the same circuit 200 and this provides an override signal which overrides the dimming adjustment to maintain a safe low temperature. The safe low temperature limit is set by internal adjustment in limiting circuit 180.

As the external incandescent style lighting dimmer is adjusted to achieve a desired luminosity by the user, the invention circuit 200 converts the curve of the adjustment desired over to a similar curve of drive power to the invention light emitting diodes. This provides a dimmable light emitting diode illumination device that substantially mimics the curve of linearity response of an incandescent light bulb.

Temperature sensor 182 is mounted operatively within the structure of the heat sink to provide temperature measurement of the components and parts of the illumination device 100 to meet the safety standards and requirements of the long duration of lifetime of the components and human safety to diminish or eliminate the likelihood of burns or risk of fire.

We claim:

1. a light emitting diode safety illumination device having thermal control dimming compatibility for use with pulse width modulated incandescent light dimmer having a temperature sensor operatively connected for overriding the luminance adjustment drive to diminish the current to said light emitting diode to maintain a safe temperature;

2. the light emitting diode safety illumination device of claim 1 having an optoisolator as part of the sensor component circuitry;

3. a light emitting diode illumination device having variable luminance control for use with a pulse width modulated incandescent light dimmer having a luminance output corresponding similarly to the adjustment control of said dimmer to diminish the current to said light emitting diode;

4. a light emitting diode safety illumination device having thermal control dimming compatibility for use with pulse width modulated incandescent light dimmer having a temperature sensor operatively connected for overriding the luminance adjustment drive to diminish the current to said light emitting diode to maintain a safe temperature while having variable luminance control corresponding to the adjustment control of said dimmer.
